(19) United States
(12) Patent Application Publication
(10) Pub. No.: US 2012/0230150 A1
(43) Pub. Date: Sep. 13, 2012

(54) Method for determining positions of sensor streamers during geophysical surveying

(76) Inventors: Gustav Göran Mattias Südow, Solna (SE); Jon Falkenberg, Jar (NO)

(21) Appl. No.: 12/932,879

(22) Filed: Mar. 9, 2011

(51) Int. Cl. G01V 1/38

(52) U.S. Cl. 367/19

(57) ABSTRACT

The geodetic position of a point on a streamer towed by a vessel in a body of water may be determined. Geodetic positions of a plurality positions along at least two of a plurality streamers towed in the body of water may be determined. Positions may be selected from the plurality of positions. Distances between pairs of the selected positions and between each of the selected positions and the point may be determined. Geodetic position of the point may be determined using the geodetic positions and distances.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates generally to the field of marine geophysical surveying. More particularly, at least in some embodiments, the invention relates to methods for determining geodetic locations of positions on streamers towed at water depths which make impractical the use of geodetic position sensor signals or tail buoys.

Marine geophysical surveying techniques known in the art include seismic surveying and electromagnetic surveying. In such surveying techniques, a survey vessel or other vessel may tow one or more streamers. A streamer is essentially a long cable with sensors disposed therein at spaced apart locations along the length of the cable. Seismic streamers may include pressure responsive sensors, particle motion responsive sensors, or combinations and variations thereof generally responsive to seismic energy propagating in a body of water. Electromagnetic sensors may include, without limitation, electrodes, wire coils, magnetometers, or other devices to detect electromagnetic fields in the body of water. Such fields may be naturally occurring or may be induced by actuating an electromagnetic energy source in the water.

The foregoing surveys may be used to generate images of the distribution of acoustic and electrical properties of formations below the water bottom. Such images may be used to predict the location of hydrocarbons or other useful fluids prior to or in conjunction with drilling operations. Generating accurate images requires, among other things, accurate location of each of the sensors on each of the streamers at all times during survey operations.

In seismic surveying, systems and methods for determining geodetic position of each sensor on several seismic sensor streamers include a system and method described in U.S. Pat. No. 7,376,045 issued to Falkenberg et al. It is desirable to have a method that can also be used with electromagnetic sensor streamers for precisely determining geodetic position of each of the sensors on one or more of such electromagnetic streamers. It is also desirable to have a method that can enable location of any type of geophysical sensor streamer operated at a depth such that use of geodetic position sensor signals or tail buoys is impractical.

### SUMMARY OF THE INVENTION

A method for determining geodetic position of at least one point on at least one second streamer towed by a vessel in a body of water according to some embodiments of the disclosure comprises determining geodetic positions of a plurality of first positions along at least two of a plurality of first streamers towed in the body of water. The method also comprises selecting positions from the plurality of first positions. The method also comprises determining distances between pairs of the selected positions and between each of the selected positions and the at least one point. The method also comprises determining geodetic position of the at least one point using the geodetic positions and distances.

A system for geophysical surveying according to some embodiments of the disclosure comprises a tow vessel. The system also comprises a plurality of first streamers coupled to the tow vessel, the first streamers disposed in laterally spaced apart relation to each other, at least two of the first streamers including a plurality of acoustic range detection transceivers thereon at spaced apart locations and having a tail buoy at an aft end thereof, each tail buoy including a geodetic position signal receiver. The system also comprises at least one second streamer coupled to the tow vessel, the at least one second streamer including a plurality of acoustic range detection transceivers thereon at spaced apart locations. The system also comprises computational equipment configured to determine the geodetic positions of selected positions on the at least two of the first streamers and at least one selected position on the at least one second streamer from distance measurements made by the acoustic range detection transceivers and the geodetic position signal receivers.

A method for geophysical surveying according to some embodiments of the disclosure comprises determining geodetic positions of a plurality of first positions along at least two of a plurality of first streamers towed by a vessel in a body of water at a first depth. The method also comprises selecting positions from the plurality of first positions. The method also comprises determining distances between pairs of the selected positions and between each of the selected positions and at least one point on at least one second streamer operated at a second depth in the body water. The method also comprises determining geodetic position of the at least one point using the geodetic positions and distances. The method also comprises actuating a geophysical source disposed in the body of water at selected times. The method also comprises detecting geophysical signals with a plurality of geophysical sensors disposed on at least one of the first and second streamers.

Other aspects and advantages of the invention will be apparent from the following description and the appended claims.

### BRIEF DESCRIPTION OF THE DRAWINGS

FIG. 1 is a view in the vertical plane of an example embodiment of a combined electromagnetic and seismic survey system.

FIG. 2 is a plan view of the survey system shown in FIG. 1.

### DETAILED DESCRIPTION

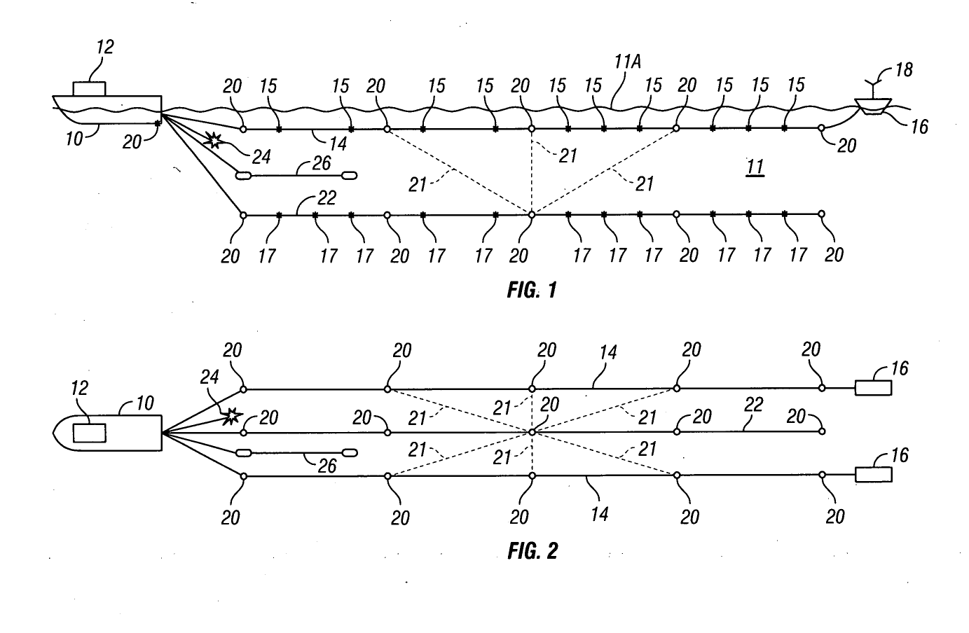

FIG. 1 shows a view in the vertical plane of an example embodiment of a geophysical survey system. The present embodiment may be a combined electromagnetic and seismic marine survey system. The combined electromagnetic and seismic marine survey system may include a survey vessel 10 that moves along the surface 11A of a body of water 11 such as a lake or ocean. The survey vessel 10 may include thereon certain equipment, shown generally at 12 and referred to for convenience as a “recording system.” The recording system 12 may include any or all of the following components: (none of which is shown separately for clarity of the illustration) devices for navigating the survey vessel 10 including determining its geodetic position at any time; devices for recording sensor signals from various sensors deployed in the water on streamers (explained below); and devices for actuating one or more geophysical energy sources. The recording system 12 may also include computational equipment, including both hardware and software, for determining distances and geodetic positions based upon user input, information from sensor signals, acoustic range detection transceiver signals, and/or other navigational information. In the present example, such sources may include a seismic energy source 24 and an electromagnetic transmitter 26.

The seismic energy source 24 may be any type of marine seismic energy source known in the art, including, without limitation, air guns or arrays thereof, marine vibrators or arrays thereof, and water guns or arrays thereof. The electromagnetic transmitter 26 may be any device known in the art for inducing a time varying electromagnetic field in a body of water, including without limitation, spaced apart electrodes and wire coils or loops. The seismic energy source 24 and/or the electromagnetic transmitter 26 may each be towed at a selected depth in the water appropriate for the type of signals to be emitted and detected therefrom.

The survey vessel 10, or another vessel (not shown) may tow a plurality of first geophysical sensor streamers 14. In the present example embodiment such geophysical sensor streamers may be seismic sensor streamers 14 towed at a first selected depth in the water. The seismic sensor streamers 14 may include a plurality of longitudinally spaced apart seismic sensors 15, which may include particle motion responsive sensors, pressure or pressure time gradient responsive sensors, and any other type of sensor known in the art for detecting seismic energy propagating through the water 11. The seismic sensor streamers 14 may include one or more depth sensors 19, which may be pressure sensors or any other device known in the art for determining depth of the seismic sensor streamers 14 in the water 11. During surveying, the seismic energy source 24 may be actuated at selected times, and seismic energy may be detected by the seismic sensors 15. The recording system 12 may make a recording of the signals detected by each of the seismic sensors 15, typically indexed with respect to the actuation time of the seismic energy source 24. It will be appreciated by those skilled in the art that the foregoing example embodiment of seismic sensor streamers 14 represents only one type of geophysical sensor streamer, and other types may be used in other embodiments. In such other embodiments, the seismic sensors 15 may be substituted and/or accompanied by any other type of geophysical sensor, including, without limitation, electromagnetic sensors. In some embodiments, the geophysical sensor streamers 14 may neither include seismic energy sensors nor electromagnetic sensors. Nonetheless, for notational ease, geophysical sensor streamers 14 may be referred to herein as seismic sensor streamers 14.

The seismic sensor streamers 14 may also include a plurality of acoustic range detection transceivers (“ARD transceivers”) 20 at spaced apart locations along the seismic sensor streamers 14. In some embodiments, one or more ARD transceivers 20 may also be located proximate the survey vessel 10. The seismic sensor streamers 14 are operated at such first depth in the water that they may be terminated at their respective aft ends by a tail buoy 16. (As used herein, “aft” refers to the trailing direction while the streamer is being towed.) Each tail buoy 16 may include a geodetic position signal receiver 18, such as a global navigation satellite system (“GNSS”) receiver. The combination of geodetic position signal receiver 18 on each of the tail buoys 16, on the survey vessel 10 (part of the recording system 12), and ARD transceivers 20 may be used to infer the geodetic position of each seismic sensor 15 on each seismic sensor streamer by determining relative position of each ARD transceiver 20 with respect to others of the ARD transceivers 20 and with respect to the geodetic position signal receiver 18. The relative positions may be determined by trilateration of a plurality of distance measurements 21 made by the ARD transceivers 20. By combining the relative positions thus determined and the geodetic positions determined by detecting geodetic position signals at the geodetic position signal receivers 18, the geodetic position at each point along each seismic sensor streamer 14 may be determined. It is thus possible to determine the geodetic position of each seismic sensor 15 along each of the seismic sensor streamers 14 at any time. An example system and method for determining such geodetic positions including examples ARD transceivers 20 and geodetic position signal receivers 18 is more fully explained in U.S. Pat. No. 7,376,045 issued to Falkenberg et al., incorporated herein by reference. In some embodiments, the distance measurements 21 and measurements from the geodetic position signal receivers 18 may be communicated to the recording system 12 for determining geodetic positions at any selected positions along the seismic sensor streamers 14 and, as will be explained further below, the geodetic position at any point along one or more electromagnetic sensor streamers.

In the present embodiment, the survey vessel 10 or another vessel (not shown) may tow one or more second geophysical sensor streamers 22 at a second depth in the water 11. In the present example embodiment, the second geophysical sensor streamer(s) 22 may be electromagnetic sensor streamer(s) 22. In other embodiments, the second geophysical sensor streamer(s) may have any type of geophysical sensor, including seismic sensors. In the present embodiment, wherein the second geophysical sensor streamer(s) 22 are electromagnetic sensor streamers, the electromagnetic sensor streamer(s) 22 may include a plurality of longitudinally spaced apart electromagnetic sensors 17. The electromagnetic sensors 17 may be any device known in the art for detecting one or more components of an electromagnetic field in the water 11. Such electromagnetic sensors 17 may include, without limitation, spaced apart electrodes, wire loops or coils, and magnetometers. During survey operations, the electromagnetic transmitter 26 may be actuated by passing electric current through the electromagnetic transmitter 26 at selected times. The electric current may include one or more transient events (e.g., switching current on, switching current off, reversing current polarity, or combinations thereof, either individual or in a predetermined sequence such as a pseudo random binary sequence). The electric current may also include one or more individual frequencies of alternating current, and may be switched on for a selected time duration. The recording system 12 may record signals detected by each of the electromagnetic sensors 17.

As will be appreciated by those skilled in the art with the benefit of this disclosure, the electromagnetic sensor streamer(s) 22 may be towed at substantially greater depth in the water 11 than the seismic sensor streamers 14. In some embodiments, for example, electromagnetic sensor streamer 22 may be towed at depths of between about 20 m and about 50 m. In other embodiments, electromagnetic sensor streamer 22 may be towed at depths of between about 50 m and about 100 m or more. Thus, it may be impractical to use geodetic position sensor signals or tail buoys to determine the geodetic position of any one or more of the electromagnetic sensors 17 along the electromagnetic sensor streamer(s) 22. In the present embodiment, therefore, the electromagnetic sensor streamer(s) 22 may include a plurality of ARD transceivers 20 at spaced apart locations along the length of the electromagnetic sensor streamer(s) 22. In the present embodiment, the ARD transceivers 20 disposed on the electromagnetic sensor streamer(s) 22 may be used to determine relative position of any point along the electromagnetic sensor streamer(s) 22 with reference to the position of any point along the seismic sensor streamers 14. Determining relative position of any point along the electromagnetic sensor streamer(s) 22 with reference to the position of any point along the seismic sensor streamers 14 may be performed as explained in the Falkenberg '045 patent. It is therefore possible to infer the geodetic position at any point along the electromagnetic sensor streamer(s) 22. It is also possible, therefore, to determine the geodetic position of any one or more of the electromagnetic sensors 17 along the electromagnetic sensor streamer(s) 22. When streamers are operated at different depths as in the present example embodiment, it is also desirable to be able to determine depth of the deeper operated streamers while minimizing the number of depth sensors required. In some embodiments, the distances 21 between a plurality of ARD transceivers 20 on the seismic sensor streamers 14 and any or all of the ARD transceivers 20 on the electromagnetic sensor streamer(s) 22 may also be used to determine depth in the water 11 at any position along the electromagnetic sensor streamer(s) 22, because the depth of the seismic sensor streamers 14 may be measured using one or more depth sensors such as shown at 19 in FIG. 1. Such capability may reduce the number of depth sensors (not shown) required to be used with each electromagnetic sensor streamer 22, or may eliminate the need for depth sensors on the electromagnetic sensor streamer(s) 22 entirely.

The example embodiment of FIG. 1 is shown in plan view in FIG. 2. In order to determine geodetic position of any point along each of the seismic sensor streamers 14 is generally required to tow two or more seismic sensor streamers 14. However, it is possible, using the arrangement shown in FIG. 2 to determine geodetic position at any point along only one electromagnetic sensor streamer 22.

It will be readily appreciated by those skilled in the art with the benefit of this disclosure that the scope of the present invention is not limited to towing and locating seismic sensor streamers and one or more electromagnetic sensor streamers as shown in and explained with reference to FIGS. 1 and 2. As may be inferred from the descriptions of the various streamers, the scope of the invention may extend to any first streamer operated at a first depth and having a tail buoy with geodetic position signal receiver thereon. A plurality of such first streamers may be arranged in laterally spaced apart relation as shown in FIG. 2. One or more second streamers may operate at a second depth in the water. Using the technique explained above with reference to seismic sensor streamers and electromagnetic sensor streamers, it may be possible to locate a geodetic position of at least one point on such second streamers. An example of such an arrangement may include “over/under” seismic surveying, wherein both the first and second streamers may include seismic sensors, as described, for example, in “Adding streamers to an over/under configuration can improve imaging”, by Ralf Ferber, World Oil, Sept. 2008. Other examples will occur to those skilled in the art with the benefit of this disclosure.

A method according to the various aspects of the invention may enable determination of geodetic positions of a plurality of geophysical sensors along one or more geophysical sensor streamers without the need to measure geodetic position directly at any point along the one or more geophysical sensor streamers, e.g., electromagnetic sensor streamers operated in conjunction with seismic sensor streamers. Likewise, methods of conducting a geophysical survey may benefit from the determination of geodetic positions of a plurality of geophysical sensors along one or more geophysical sensor streamers without the need to measure geodetic position directly at any point along the one or more geophysical sensor streamers.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining geodetic position of at least one point on at least one second streamer towed by a vessel in a body of water, comprising:
determining geodetic positions of a plurality of first positions along at least two of a plurality of first streamers towed in the body of water;
selecting positions from the plurality of first positions;
determining distances between pairs of the selected positions and between each of the selected positions and the at least one point; and
determining geodetic position of the at least one point using the geodetic positions and distances.

2. The method of claim 1 wherein the distances are determined by measuring acoustic travel time between spaced apart acoustic range detection transceivers.

3. The method of claim 1 wherein the determining geodetic positions of the plurality of first positions comprises:
determining a geodetic position of at least one position along the at least two of the plurality of first streamers; and
using the distances to determine the geodetic positions of the plurality of first positions.

4. The method of claim 1 further comprising determining a depth in the water of the at least one point using the distances.

5. The method of claim 1 wherein the at least one second streamer comprises a plurality of electromagnetic sensors.

6. The method of claim 5 further comprising:
actuating an electromagnetic transmitter disposed in the body of water at selected times; and
detecting electromagnetic signals with the plurality of electromagnetic sensors.

7. The method of claim 6 further comprising determining a geodetic position of at least some of the plurality of electromagnetic sensors using the determined geodetic positions and the distances.

8. The method of claim 1 wherein at least one of the plurality of first streamers comprises a plurality of seismic sensors.

9. The method of claim 8 further comprising:
actuating a seismic energy source disposed in the body of water at selected times; and
detecting seismic signals with the plurality of seismic sensors.

10. The method of claim 9 further comprising determining a geodetic position of at least some of the plurality of seismic sensors using the determined geodetic positions and the distances.

11. The method of claim 1 wherein the determining geodetic positions of the plurality of first positions comprises detecting a geodetic position signal at an aft end of two or more of the plurality of first streamers.

12. The method of claim 11 wherein the determining geodetic positions of the plurality of first positions further comprises detecting a geodetic position signal proximate the vessel.

13. The method of claim 1 wherein the second streamer and at least one of the plurality of first streamers comprise seismic sensors.

14. A system for geophysical surveying, comprising:
a tow vessel;
a plurality of first streamers coupled to the tow vessel, the first streamers disposed in laterally spaced apart relation to each other, at least two of the first streamers including a plurality of acoustic range detection transceivers thereon at spaced apart locations and having a tail buoy at an aft end thereof, each tail buoy including a geodetic position signal receiver;
at least one second streamer coupled to the tow vessel, the at least one second streamer including a plurality of acoustic range detection transceivers thereon at spaced apart locations; and
computational equipment configured to determine the geodetic positions of selected positions on the at least two of the first streamers and at least one selected position on the at least one second streamer from distance measurements made by the acoustic range detection transceivers and the geodetic position signal receivers.

15. The system of claim 14 wherein at least one first streamer comprises a plurality of seismic sensors at spaced apart locations.

16. The system of claim 14 wherein the at least one second streamer comprises a plurality of sensors at spaced apart locations, wherein the plurality of sensors include at least one sensor selected from the group consisting of: seismic sensors, and electromagnetic sensors.

17. The system of claim 14 further comprising at least one seismic energy source coupled to the tow vessel.

18. The system of claim 14 further comprising at least one electromagnetic transmitter coupled to the tow vessel.

19. The system of claim 14 wherein the at least two first streamers comprise water depth sensors.

20. The system of claim 19 wherein the computational equipment is configured to determine a depth in a body of water of the at least one selected position on the at least one second streamer.

21. A method for geophysical surveying comprising:
determining geodetic positions of a plurality of first positions along at least two of a plurality of first streamers towed by a vessel in a body of water at a first depth;
selecting positions from the plurality of first positions;
determining distances between pairs of the selected positions and between each of the selected positions and at least one point on at least one second streamer operated at a second depth in the body water;
determining geodetic position of the at least one point using the geodetic positions and distances;
actuating a geophysical source disposed in the body of water at selected times; and
detecting geophysical signals with a plurality of geophysical sensors disposed on at least one of the first and second streamers.

22. The method of claim 21 wherein the distances are determined by measuring acoustic travel time between spaced apart acoustic range detection transceivers.

23. The method of claim 21 wherein the determining geodetic positions of the plurality of first positions comprises:
determining a geodetic position of at least one position along the at least two of the plurality of first streamers; and
using the distances to determine the geodetic positions of the plurality of first positions.

24. The method of claim 21 further comprising determining a depth in the water of the at least one point using the distances.

25. The method of claim 21 wherein the determining geodetic positions of the plurality of first positions comprises detecting a geodetic position signal at an aft end of two or more of the plurality of first streamers.

26. The method of claim 21 wherein the determining geodetic positions of the plurality of first positions further comprises detecting a geodetic position signal proximate the vessel.

27. The method of claim 21 wherein the geophysical sensors streamers comprise at least one sensor selected from the group consisting of: electromagnetic sensors, and seismic sensors.
